(19) United States
(12) Patent Application Publication
(10) Pub. No.: US 2010/0186955 A1
(43) Pub. Date: Jul. 29, 2010

(54) METHOD OF WELL CEMENTING

(76) Inventors: Arild Saasen, Stavanger (NO); Hallvar Eide, Stavanger (NO); Rune Godoy, Stavanger (NO); Per Amund Amundsen, Stavanger (NO)

Correspondence Address: Ballard Spahr LLP, SUITE 1000, 999 PEACHTREE STREET, ATLANTA, GA, 30309-3915, US

(21) Appl. No.: 12/451,805

(22) PCT Filed: Jun. 2, 2008
(86) PCT No.: PCT/GB2008/001863

§ 371 Date: Mar. 31, 2010

(30) Foreign Application Priority Data
Jun. 1, 2007 (GB) 0710521.6
Jun. 8, 2007 (GB) 0711102.4

(51) Int. Cl. E21B 33/14; C09K 8/46; E21B 17/00

(52) U.S. Cl. 166/288; 507/271; 166/65.1

(57) ABSTRACT

The invention provides a method for cementing in a lining tube in a bore hole, said method comprising placing said lining tube at a distal end of said bore hole, introducing a liquid hydraulic cement containing a setting retarder into said distal end of said bore hole, and applying a fluctuating electromagnetic or magnetic field from within said lining tube whereby to heat cement outside said lining tube directly or via a electromagnetic radiation transmitter positioned on the outside of said lining tube.

This invention relates to improvements in and relating to well cementing, and to cements used therein.

When drilling to retrieve fluids (e.g. water or more generally hydrocarbons) from subterranean reservoirs, drilling is generally done using a drill bit at the end of a drill string running from the drill rig which may be on land or water. The drill string is a pipe, generally of steel but also possibly of another metal, e.g. aluminium or titanium, or a composite (generally carbon fibre reinforced plastics). Steel drill strings are cheaper than titanium or composite but are heavier than those of these other materials.

To enable the desired fluid to be recovered without contamination by undesired fluids (e.g. water) from other strata through which the bore may pass and to prevent seepage of the desired fluid from the bore into other strata, once drilled the bore is lined, with a tube, generally of steel for economic and other reasons, and the gap between this lining tube (referred to as a casing or liner) is sealed with hydraulic cement to ensure the desired fluid travels up to the surface through the lining tube rather than through gaps between the lining tube and the surrounding rock (also referred to as matrix or formation). Otherwise there is a risk that the fluid escapes into the matrix or reaches the surface uncontained giving rise to the risk of fire. The lining tube is then pierced at the site at which extraction is to take place, e.g. using an explosive device.

The lining tube remains in place and thus there is a strong economic incentive not to use tubes of expensive materials such as titanium or composites.

Placement of the lining tube may be done in one operation or alternatively in stages, each covering a length of the bore successively further away from the drill rig. In the case of successive lining tube placement, a liner string is fed to the bore end through the existing cemented-in lining tube (the casing) and then expanded to roughly the same internal diameter as the casing. This is generally achieved through brute force (internally applied mechanical pressure) and requires the liner string to be expandable.

In the cementing operation, liquid unset cement is pumped down through the lining tube and forced back up the bore from the distal end to fill the annulus between the tube and the matrix as far from the distal end of the bore as is required. It is then allowed to set, cementing the lining tube into place. To penetrate the annulus fully, the unset cement must be a relatively non-viscous liquid and as a result the setting period of the cement is lengthy and during this period no further drilling or well completion activities can take place.

Where a liner is positioned below a casing, then it is often the case that liner expansion is effected after the unset cement has been pumped into the annulus. If this is done, expansion of the liner narrows the annulus causing the proximal limit of the unset cement in the annulus to be forced further away from the distal end of the bore, eventually to reach the point at which the (already cemented-in) casing begins. If operational problems occur while liner expansion is being effected, the cement may begin to set making full expansion of the liner impossible. In this event, the liner would have to be drilled out, and a fresh liner positioned and cemented in.

There is thus a need for techniques which enable the cementing operation to be completed quickly and in a controlled fashion.

We have now found that relatively rapid and controlled setting of the cement in the annulus may be achieved by utilizing a cement containing a setting retarder and by subjecting the cement to a fluctuating electromagnetic or magnetic field capable of raising its temperature, this fluctuating field being applied from within the as yet unfixed lining tube either directly or via an electromagnetic radiation transmitter, e.g. an inductively coupled transmitter, positioned on the outside of the unfixed lining tube. Raising the temperature of the cement of course counteracts the setting retarding effects of the retarder.

Thus viewed from one aspect the invention provides a method for cementing in a lining tube in a bore hole, said method comprising placing said lining tube at a distal end of said bore hole, introducing a liquid hydraulic cement containing a setting retarder into said distal end of said bore hole, and applying a fluctuating electromagnetic or magnetic field from within or outside said lining tube whereby to heat cement outside said lining tube directly or via a electromagnetic radiation transmitter positioned on the outside of said lining tube.

The generator of the electromagnetic field may be outside or inside the lining tube. In the former case, the generator, e.g. a microwave generator, may be built onto the outside of the tube and provided with electrical leads to a connector at one end (usually the distal end) or within the tube. A down hole tool may be used to engage with the connector and provide electricity to the generator. Such lining tubes are new and form a further aspect of the invention. Viewed from this aspect the invention provides a well lining tube having positioned on the outside thereof an electromagnetic radiation generator coupled by electrical leads to a contact on an end or the inside of said tube for electricity supply. In another embodiment, the outside of the lining tube may be provided with an electromagnetic or magnetic field transmitter which serves to transmit into the cement a field generated by a generator positioned within the tube, e.g. a generator on a down hole tool. These lining tubes are also new and form a further aspect of the invention. Viewed from this aspect the invention provides a well lining tube having positioned on the outside thereof an electromagnetic radiation transmitter.

In the method of the invention, the fluctuating field is effectively used to heat the cement directly rather than to heat an element within the lining tube and hence heat the cement by heating the tube. Thus in practice the tube will be heated by the cement and will thus not become hotter than the cement. This is important, especially with metal tubes to avoid undue thermal expansion which can result in a poor cement to tube bond when the tubes contract after the cement has set and the temperature has dropped back to ambient.

The lining tube may be placed at the distal end of the bore hole before or after the liquid cement composition is introduced. In the former case, the cement composition is typically introduced through the lining tube and into the annulus between the tube and the surrounding matrix. In the latter case, the distal end of the lining tube may be sealed (ie so as to prevent cement entering the tube) or cement which enters the tube may be driven into the annulus between tube and matrix by application of a drilling fluid which is denser than the cement.

In some cases, it may only be necessary in the method of the invention to accelerate cement setting along a portion of the length of the lining tube, with the heat generated in that portion due to the cement setting serving to accelerate setting along neighbouring portions.

In this case heating the cement in the annulus using the fluctuating field need only be effected the selected length of the lining tube. This is important since the heating methods used may be different for lining tubes of different materials and since lining tubes composed of lengths of tube of different materials may then be used.

Where the lining tube length outside of which the cement in the annulus is to be heated is a composite, since composites are translucent to electromagnetic radiation heating may simply be effected by placing an electromagnetic radiation emitter, e.g. a microwave emitter, within the relevant length of the lining tube and if required drawing it along for an appropriate distance within the tube to heat the cement outside, e.g. by microwave absorption by the water in the cement. In this embodiment, an emitter with a dish antenna, eg an elipsoidal dish, may be used to focus the radiation so as to accelerate cement setting at the desired distance from the outer surface of the lining tube.

Where the relevant lining tube length is of a non-ferro/ferri magnetic metal, e.g. titanium, an electromagnetic radiation emitter within the tube may be inductively coupled to one or more electromagnetic radiation transmitters positioned on the outside of the tube since the tube is translucent to fluctuating magnetic fields and the transmitters will then emit equivalent electromagnetic radiation, again for example microwave radiation. Once again the emitter may be moved along within the tube to cause cement along the corresponding length of the annulus to be heated.

The “emitter” or generator may typically be a device in which an alternating current is used to induce the electromagnetic radiation of the desired wavelength, typically about 1 to 10 cm. If directly or inductively coupled antennae are used to emit the radiation to heat the cement, these will typically have dimensions comparable to or slightly larger than the radiation wavelength.

Where however the relevant length of the tube is of a ferri/ferromagnetic material, e.g. steel, it will be necessary to have a direct coupling from a source within the tube to transmitters positioned on the outside of the tube, e.g. via wires or waveguides travelling from within the tube to those transmitters, preferably fastened to the outside of the tube, e.g. within a robust coating material, e.g. a plastics shell.

Where a waveguide is used, this will conveniently have non-metallic, or at least non-ferrous, windows to allow transmission of radiation in and out of the waveguide but to exclude transmission of matter, eg cement, into the waveguide. Such windows may for example be of ceramic, plastics or glass. Where the lining tube is to be expanded, plastics windows are preferred and may be provided as a sleeve or coating over the relevant surface of the lining tube. Thus, for example, a first waveguide may run from a window opening into the interior of the tube, at a distance from the distal end of the tube, along the tube wall to a window or aperture in the base plate of the tube to communicate with a second wave guide on the outside of the lining tube leading from the base plate to a window on the side of the tube at a distance from the distal end. Where the lining tube has waveguide windows on the outside of the tube, these may communicate with dipole antennae (eg about 3 cm long) on the exterior of the pipe so as to propagate the radiation through the cement.

In an alternative embodiment, the lining tube may comprise a metal, eg ferrous metal, tube having apertures in the cylinder wall through which the radiation may penetrate, and a concentric plastics or composite or non-ferrous metal sleeve which serves to seal those apertures to prevent cement from passing through. The sleeve may be within or outside the apertured metal tube, preferably outside. The apertures will preferably have a smooth profile, eg circular or eliptical, so as to avoid tearing during pipe expansion. In this embodiment, as with composite lining tubes, the emitter may be disposed within the lining tube.

In a further embodiment, the plug used to seal the base plate of the lining tube after cement injection may function as the radiation emitter or may communicate power to an emitter placed on the outside of the lining tube. Thus the plug may carry an electrical connection on its upper surface which can mate with an electrical connection to a power supply on a down-hole tool. In one version, the connection serves to power an emitter within or on the underside of the plug (e.g. when in place communicating with a waveguide leading to a window on the outside of the tube at a distance from the base plate). In another version, the plug will carry electrical connections which can mate with the electrical connections of power leads to emitters on the outside of the tube.

In certain instances, e.g. when cementing ratholes, a lining pipe sealed at its distal end by a radiation translucent window, e.g. a ceramic, glass or plastics plate, may be used. In this embodiment, an emitter within the tube may serve to accelerate setting of previously placed cement below the window.

When cementing ratholes in this way, the emitter/generator, e.g. a microwave generator, may be a disposable device with its own power source that may be released to travel down hole to the distal end of the rathole. Such “release and drop” devices could be positioned during lining tube expansion or, with open-ended lining tubes even during cement pumping. If desired such devices might be powered from the surface rather than have their own power sources.

The emitter may be remote from the lining tube, eg at the drilling rig itself, with radiation being directed into the lining tube through a waveguide. That waveguide may be a suitably dimensioned drill string (empty of course of drilling fluid).

It will be realised that the lining tube itself may in certain circumstances function as the antenna which emits the radiation to heat the cement.

Lining tubes carrying emitters, lining tubes carrying waveguides, lining tubes closed by radiation translucent base plates, and apertured lining tubes with aperture-sealing sleeves are novel and form further aspects of the present invention. Base plate sealing plugs having electrical connections on their upper surfaces are also novel and form a further aspect of the invention. Down hole tools, especially expansion tools, carrying emitters or electrical connections capable of mating with connections on the upper surface of a base plate sealing plug are also novel and form further aspects of the present invention. Drill strings dimensioned to be capable of serving as microwave waveguides are also new and form further aspects of the present invention.

Fluctuating (e.g. alternating) electromagnetic or magnetic field sources (e.g. microwave emitters) are well-known, as are transmitters and inductive coupling devices and thus will not be discussed in great detail herein.

The heating effect within the concrete may be magnified by including within the concrete composition materials besides water which either absorb electromagnetic radiation (and thereby heat up) or which are caused to oscillate by an alternating field and thereby heat up the surrounding cement. Examples of the first category are metal fines of dimensions comparable to the wavelength of the electromagnetic irradiation, and chemical compounds having absorption bands at those wavelengths. Examples of the second category are ferro, ferri and superparamagnetic particles (e.g. iron oxides) which oscillate in an oscillating magnetic field. Hydraulic cement compositions containing certain such additives are new and form a further aspect of the present invention.

Thus viewed from a further aspect the invention provides an unset hydraulic cement composition, e.g. in dry pulverulent or in aqueous liquid form, comprising a hydraulic cement and an additive selected from the group consisting of metal fines, and ferromagnetic, ferrimagnetic and superparamagnetic particles.

Such additives will generally be present at 0.1 to 10% wt, especially 0.5 to 5% wt of the composition on a dry solids basin.

The cement composition used in the present invention is a hydraulic cement, i.e. an inorganic cement rather than a settable organic resin. Such cements are well-known and set and develop strength as a result of hydration. The best known such cement is Portland cement which is a combination of tricalcium silicate, dicalcium silicate, tricalcium aluminate, tetracalcium aluminoferrite, and gypsum. Other components may of course be present, for example the chemical retarders required in the compositions used according to the present invention. Examples of retarders (often also referred to as dispersants) include: lignosulphonic acid salts (e.g. the sodium and calcium salts); hydroxycarboxylic acids and their salts, e.g. gluconates and glucoheptonates; citric acid; saccharides and other polyols (e.g. glycerol, sucrose and raffinose); saccharinic acids; cellulosic polymers (e.g. carboxymethylhydroxyethylcellulose); alkylene phosphonic acids and their salts; inorganic acids and their salts (e.g. boric, phosphoric, hydrofluoric and chromic acids and their salts); sodium chloride; and metal oxides (e.g. zinc and lead oxides). For the present invention, lignosulphonate, saccharide and polyol retarders, especially lignosulphonate retarders, are preferred.

If desired, the cement compositions used according to the invention may also contain a delayed release coated setting accelerator so that, after an initial period within which setting is retarded, release of the accelerator, e.g. due to dissolution of a release delaying coating, will then serve to counteract the effects of the chemical retarders. Many inorganic salts, e.g. chlorides (e.g. calcium chloride), carbonates, silicates (for example sodium silicate), aluminates, nitrates, nitrites, sulphates, thiosulphates and hydroxides, serve as accelerators (see for example Nelson et al, “Cement additives and mechanisms of action”, Chapter 3, pages 3-1 to 3-37 in “Well cementing” Ed. Nelson and Guillot, 2nd Edition, Schlumberger, 2006, the contents of which book are hereby incorporated by reference).

The hydraulic cement used in the method of the invention may have a composition conventional in well cementing with the exception of the additives discussed above. Such cement compositions are discussed in Nelson and Guillot (supra).

When placing the cement in the method of the invention, a preselected volume of cement is pumped down hole and into the annulus. The lining tube may then be sealed at its distal end to prevent re-entry of the cement into the tube, or alternatively a quantity of a denser liquid, e.g. densified drilling fluid, may then be pumped down hole to prevent such re-entry.

The present invention is particularly suitable for use in cementing expandable liners, especially where line expansion is effected from distal to proximal end (as premature cement setting would otherwise leave the liner expansion tool on the distal side of an unexpanded length of liner surrounded by prematurely set cement). Devices for distal to proximal liner expansion are currently supplied by Enventure.

The electromagnetic or magnetic field used in the method of the present invention may be applied using a down-hole tool connected to and controlled by the drill rig on the surface. If desired this may be the same tool as is used for liner expansion, especially where expansion is from the distal to proximal end. Down-hole tools adapted for creation of such fields are novel and form a further aspect of the present invention.

Embodiments of the present invention will now be described with reference to the following non-limiting Examples and to the accompanying drawings, in which:

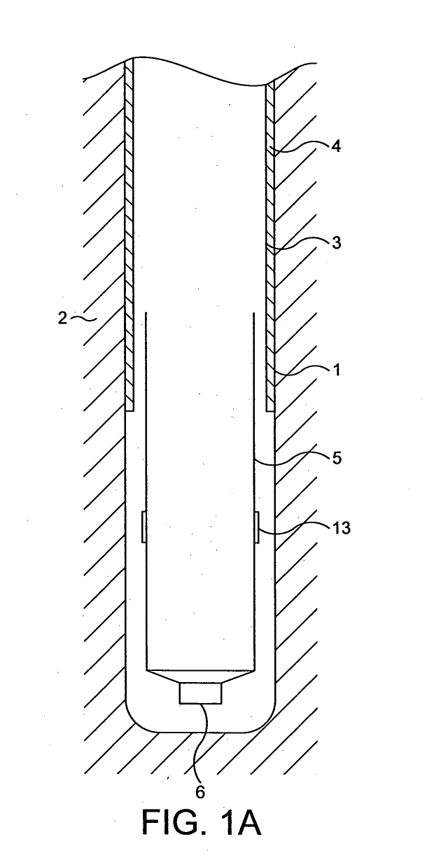

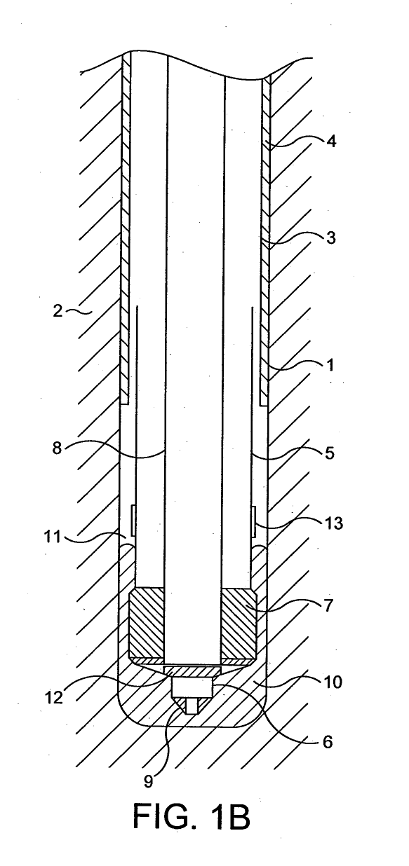

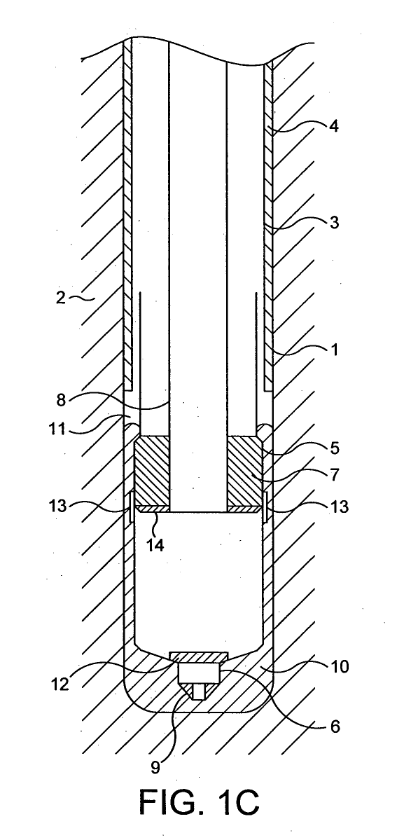

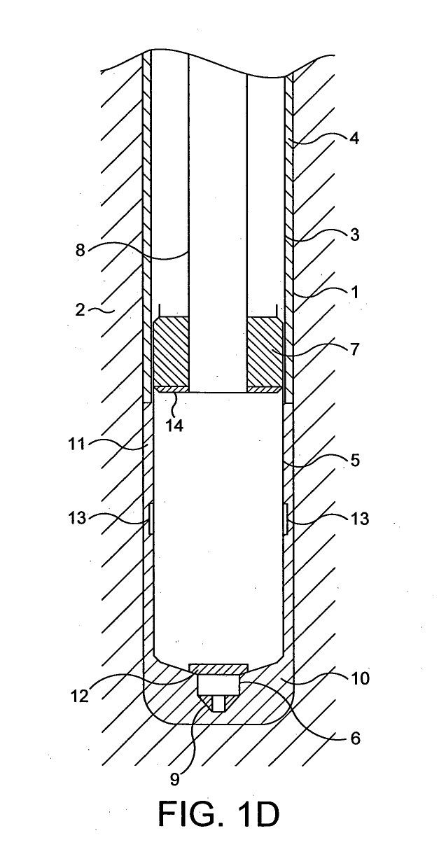

FIGS. 1A to 1D are schematic diagrams showing the placement of cement, expansion of an expandable liner, and curing of cement at the distal end of a bore;

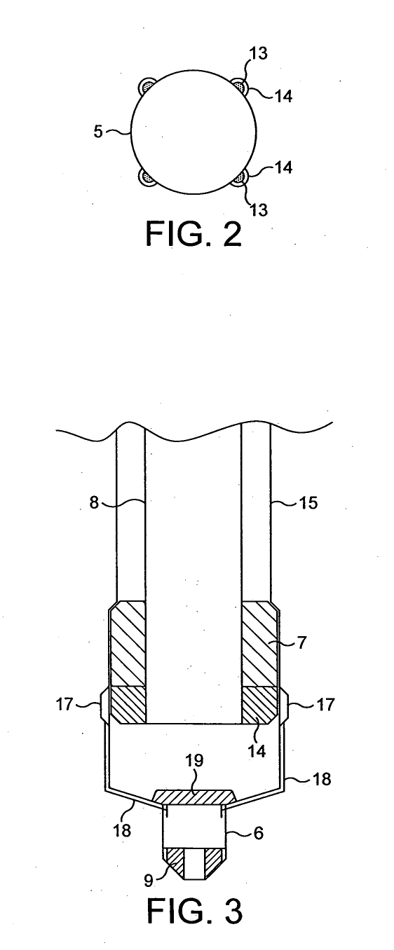

FIG. 2 is a schematic diagram showing the placement of transmitters on the exterior of a liner pipe;

FIG. 3 is a schematic diagram showing the direct coupling of a down-hole tool to transmitters on the exterior of a liner pipe; and

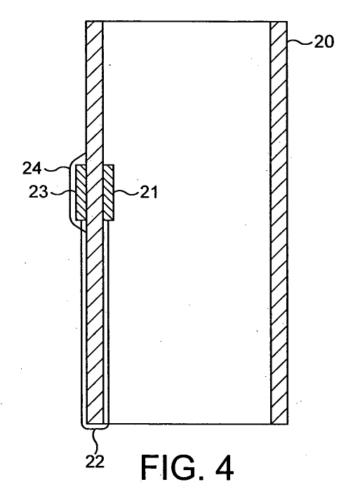

FIG. 4 is a schematic drawing of a lining tube having a field generator on its outside.

Referring to FIG. 1A there is shown a bore 1 within surrounding matrix 2 in which a casing 3 is cemented in place by set cement 4. Disposed within the bore 1 and partially within casing 3 is a titanium liner 5 sealed at distal end by end cap 6 and provided on its exterior with microwave transceiver antennae 13.

Referring to FIG. 1B, expansion tool 7 attached to hollow string 8 is placed at the distal end of liner 5 and expanded, causing the distal end of liner 5 to expand circumferentially. A dart 9 pumped through string 8 at the head of a volume of unset cement 10 has pierced end cap 6 allowing the cement to pass into the annulus 11 between liner 5 and matrix 2. A second dart 12, pumped following unset cement 10, has sealed the distal end of liner 5.

Referring to FIG. 1C, motion of expansion tool 7 away from the distal end of liner 5 has caused the further expansion of the liner 5 in the proximal direction causing the unset cement 10 to penetrate the annulus further in the proximal direction. As expansion tool 7 passes the antennae 13 on the exterior of liner 5, microwave irradiation is emitted from generator 14 on tool 7 which inductively couples to cause antennae 13 to emit microwave radiation into the adjacent unset cement 10 causing its setting to be accelerated.

Referring to FIG. 1D, further motion of expansion tool 7 in the proximal direction brings the unset concrete to reach the casing 3/liner 5 point of contact and thereafter expands liner 5 within casing 3. On removal of expansion tool 7, a drill string may be inserted into the bore, through casing 3 and liner 5 and used to drill through end cap 6 and beyond whereby to extend the bore.

Referring to FIG. 2, there is shown a cross-section through liner 5 at antennae 13 showing these encased in protective plastics coat 14.

Referring to FIG. 3, there is shown an alternative arrangement in which steel liner 15 is provided on its outside with transmitters 17 connected by protected wires 18, and inductively via dart 9, to a microwave generator 19 on a cement setter tool. In this embodiment, non-ferro/ferrimagnetic dart 9 serves, as in FIG. 1, to seal the proximal end of liner 15 but also serves to inductively couple the microwave generator to the transmitters 17.

Referring to FIG. 4 there is shown a lining tube 20 with a microwave generator 23 attached to its outside protected by microwave transparent protective coat 24 and connected by electric lead 22 to electricity supply contacts 22 on the inside of the tube. Current is supplied to generator 23 by a down hole tool (not shown) which contacts electricity supply contacts 22.

### EXAMPLE 1

### Microwave-Accelerated Setting of Retarded Cement Composition

A cement mix consisting of 396 g Portland cement, 174.5 g water and 1 g lignosulphonate was mixed in a Waring blender in accordance with the API specification (no. 10 or 13) for testing well cements. After blending, the upper part in the blender was removed to avoid any remaining inhomogeneities in the resulting slurry. Thereafter, the slurry was transferred into two approximately 4 cl translucent plastic cylinders. Each of these cylinders was sealed with a lid leaving an air bubble inside. One cylinder was left in ambient conditions (cylinder 1). A steel screw was placed within the second cylinder before it was sealed. This cylinder was then transferred to a 80W microwave oven (cylinder 2). Microwave irradiation of cylinder 2 was effected for 15 seconds, then it was taken out to cool down for 10 minutes and then it was once again exposed to the microwave irradiation for 15 seconds. After about one hour and 20 minutes from mixing, cylinders 1 and 2 were examined. When cylinder 1 was rolled on a table top, the air bubble remained on top, indicating that the cement inside was still liquid. Some gel structure was present, but not much as it required only an initial shake to make the cement flow out of the cylinder. When cylinder 2 was rolled on the table top, the air bubble moved with the cylinder showing the cement to have gelled significantly. Only with relatively vigorous shaking was it possible to cause the cement to leave the cylinder. The temperature in cylinder 1 was about 20° C. (ambient temperature) while that in cylinder 2 was about 40° C.

1. A method for cementing in a lining tube in a bore hole, said method comprising placing said lining tube at a distal end of said bore hole, introducing a liquid hydraulic cement containing a setting retarder into said distal end of said bore hole, and applying a fluctuating electromagnetic or magnetic field from within or outside said lining tube whereby to heat cement outside said lining tube directly or via an electromagnetic radiation transmitter positioned on the outside of said lining tube.

2. A method as claimed in claim 1 comprising applying a fluctuating electromagnetic or magnetic field from within said lining tube.

3. A method as claimed in claim 2 wherein the cement is heated via an electromagnetic radiation transmitter positioned on the outside of said lining tube.

4. A method as claimed in claim 3 wherein said tube is of a ferri/ferromagnetic material.

5. A method as claimed in claim 1 comprising applying a fluctuating electromagnetic or magnetic field from a field generator positioned on the outside of said lining tube.

6. A method as claimed in claim 1 wherein said tube is an expandable liner.

7. A method as claimed in claim 6 wherein expansion of said liner is effected from the distal to the proximal end.

8. A method as claimed in claim 2 wherein said tube is of a material translucent to fluctuating magnetic fields and wherein said field acts through said tube to heat the cement.

9. A well lining tube having positioned on the outside thereof an electromagnetic radiation transmitter.

10. A well lining tube having positioned on the outside thereof an electromagnetic radiation generator coupled by electrical leads to a contact on an end or the inside of said tube for electricity supply.

11. An unset hydraulic cement composition comprising a hydraulic cement and an additive selected from the group consisting of metal fines, and ferromagnetic, ferrimagnetic and superparamagnetic particles.

12. A composition as claimed in claim 11 in dry pulverulent form.

13. A method as claimed in claim 2 wherein said tube is an expandable liner.

14. A method as claimed in claim 3 wherein said tube is an expandable liner.

15. A method as claimed in claim 4 wherein said tube is an expandable liner.

16. A method as claimed in claim 5 wherein said tube is an expandable liner.
